(19) United States
(12) Patent Application Publication
(10) Pub. No.: US 2005/0186336 A1
(43) Pub. Date: Aug. 25, 2005

(54) Manufacturing method and structure of a pencil surface

(76) Inventor: Hsin-Ti Su, Shihlin District (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/780,651

(22) Filed: Feb. 19, 2004

(51) Int. Cl. B43K 7/06

(52) U.S. Cl. 427/202; 427/203; 401/192

(57) ABSTRACT

A manufacturing method of a pencil surface includes the following steps. Gluing: an outer periphery of a barrel of the pencil is allover glued for forming a glue layer. Forming reflective layer: multiple glitters are fully adhered onto the outer periphery of the barrel to form a reflective layer. Forming a transparent layer: the barrel is fully dipped into transparent glue for forming a smooth transparent layer on the rough reflective layer when the barrel is picked up from the transparent glue and the transparent glue is dried. Patterning: the transparent layer is patterned for providing a vivid appearance of a pencil.

### BACKGROUND OF THE INVENTION

1. Field of the Invention

The present invention relates to a manufacturing method and structure of a pencil surface, and more particularly to a manufacturing method and structure of a pencil surface for providing a vivid appearance to a pencil.

2. Description of Related Art

A pencil usually has a barrel. For user to easily sharpen the pencil and reducing the manufacturing cost, the barrel usually is wooden and made of vulgar wood. Consequently, the conventional pencil has a monotonous appearance.

As a result, some manufacturers paint the periphery of the barrel of the pencil, print patterns on the paint layer and sprinkle some glitters on the outer periphery of the pencil. However, the glitters may cover a part of the pattern so that this skill is gradually replaced.

Consequently, another conventional pencil with glitters in accordance with the prior art shown in FIG. 4 is marketed. The conventional pencil includes an outer periphery coated with glitters for forming a reflective layer (5) and a transparent heat-shrinkable tubing (6) sleeved onto the outer periphery of the conventional pencil. The heat-shrinkable tubing (6) is previously patterned and securely coated with the outer periphery of the conventional pencil after heating.

With reference to FIG. 5, the manufacturing method of the conventional pencil comprises the following steps:

1. The outer periphery of the barrel of the conventional pencil is painted.

2. The outer periphery of the barrel is glued.

3. Multiple glitters are adhered all over the outer periphery of the barrel to form a reflective layer (5).

4. A transparent heat-shrinkable tubing is sleeve on the barrel.

5. The heat-shrinkable tubing is securely coated on the barrel after being heated.

However, the outer periphery of the barrel is rough so that the patterns cannot be directly printed on the outer periphery of the barrel. Consequently, the patterned heat-shrinkable tubing is necessary to the conventional pencil for providing a vivid appearance. However, the heat-shrinkable tubing (6) may reduce the reflective effect of the glitters. Furthermore, the heat-shrinkable tubing (6) may be broken under a bad temperature control, especially when the barrel of the pencil is polygonal.

The present invention has arisen to mitigate and/or obviate the disadvantages of the conventional manufacturing method and structures of a pencil surface.

### SUMMARY OF THE INVENTION

The main objective of the present invention is to provide an improved manufacturing method of a pencil surface that is simplified.

To achieve the objective, the manufacturing method in accordance with the present invention comprises the following steps. Gluing: an outer periphery of a barrel of the pencil is allover glued for forming a glue layer. Forming reflective layer: multiple glitters are fully adhered onto the outer periphery of the barrel to form a reflective layer. Forming a transparent layer: the barrel is fully dipped into transparent glue for forming a smooth transparent layer on the rough reflective layer when the barrel is picked up from the transparent glue and the transparent glue is dried. Patterning: the transparent layer is patterned for providing a vivid appearance of a pencil.

Further benefits and advantages of the present invention will become apparent after a careful reading of the detailed description with appropriate reference to the accompanying drawings.

### BRIEF DESCRIPTION OF THE DRAWINGS

FIG. 1 is a diagram chart of a manufacturing method of a pencil surface in accordance with the present invention;

FIG. 2 is a perspective view of a pencil that has a surface made of the manufacturing method as shown in FIG. 1;

FIG. 3 is a partially cross-sectional view of the pencil in FIG. 2;

FIG. 3A is a partially enlarged view of FIG. 3;

FIG. 4 is an exploded perspective view of a conventional pencil in accordance with the prior art; and

FIG. 5 is a diagram chart of a manufacturing method of the conventional pencil in FIG. 4.

### DETAILED DESCRIPTION OF THE INVENTION

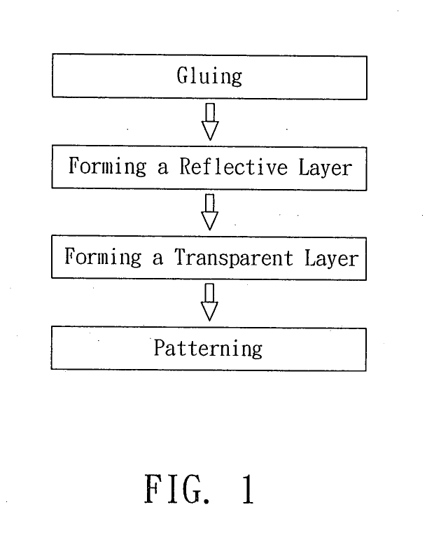

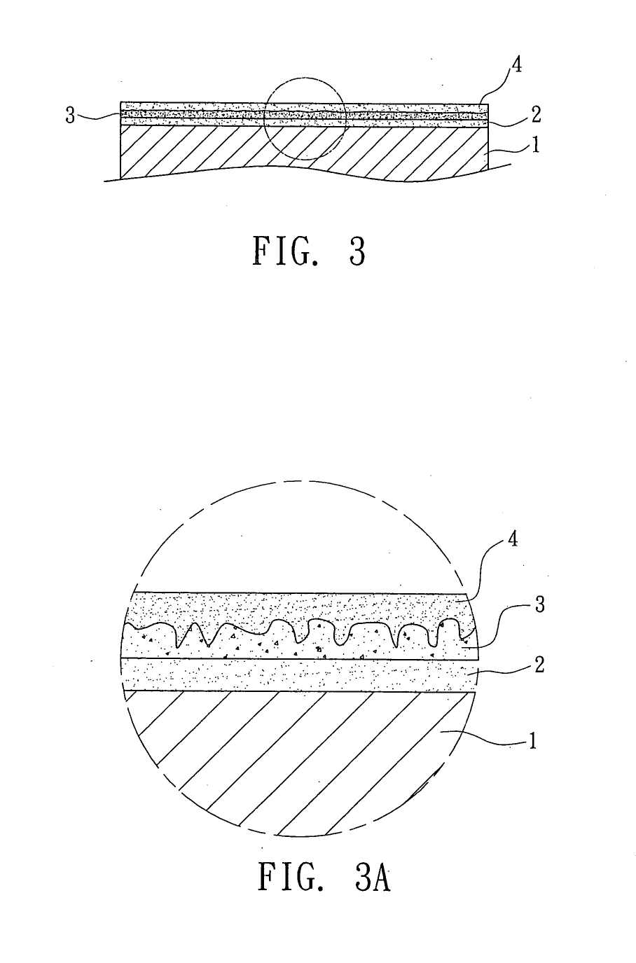

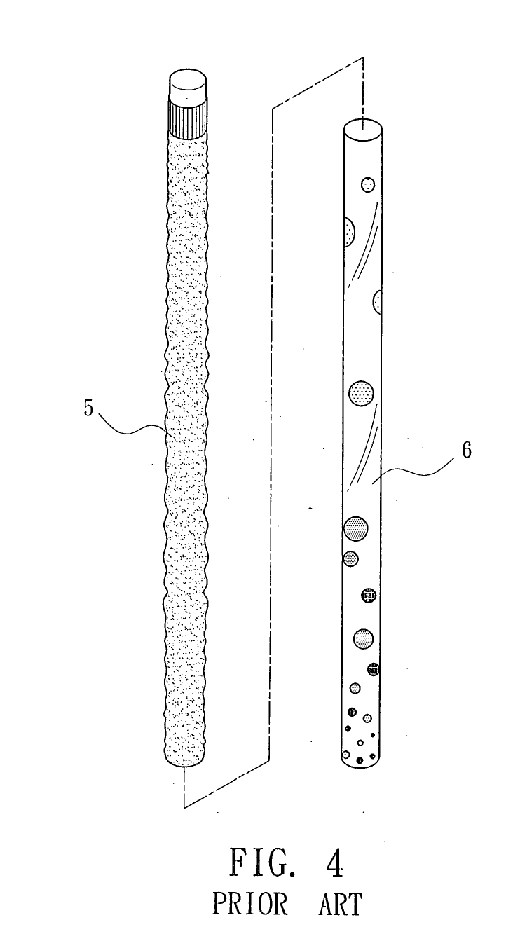

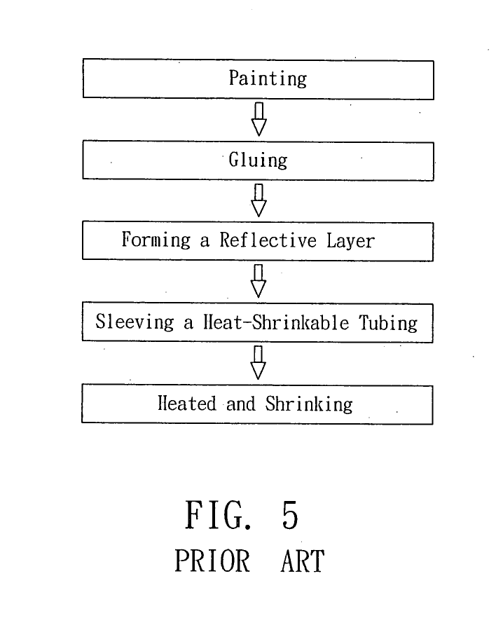

Referring to the drawings and initially to FIGS. 1, 3 and 3A, a manufacturing method of a pencil surface in accordance with the present invention comprises the following steps.

1. Gluing: an outer periphery of a barrel of the pencil is allover glued for forming a glue layer.

2. Forming a reflective layer: multiple glitters are fully adhered onto the outer periphery of the barrel to form a reflective layer.

3. Forming a transparent layer: the barrel is fully dipped into transparent glue for forming a smooth transparent layer on the rough reflective layer when the barrel is picked up from the transparent glue and the transparent glue is dried.

4. Patterning: the transparent layer is patterned for providing a vivid appearance of a pencil.

As described above, the transparent glue is resin solution and contains resin about 8˜15 percentage for providing a high transparency to the transparent layer. Furthermore, the heat-shrinkable tubing of the conventional manufacturing method of a pencil surface is unnecessary to the present invention so that the manufacturing processes of the pencil surface are simplified.

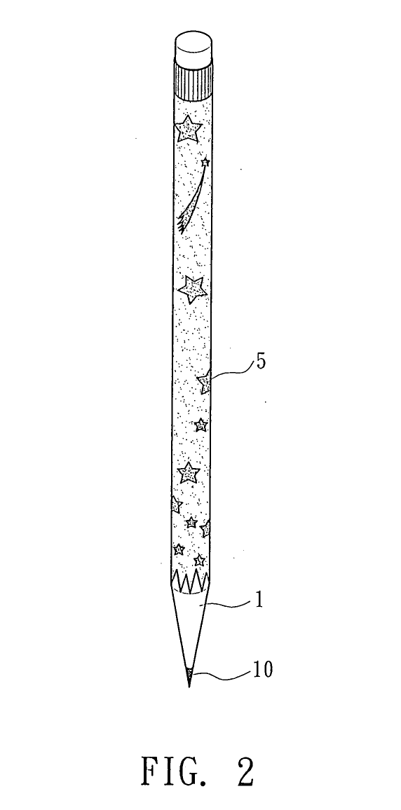

With reference to FIGS. 2, 3 and 3A, the pencil surface made from the manufacturing method in accordance with the present invention comprises a glue layer (2) adapted to be formed on an outer periphery of a barrel (1) in which a cartridge (10) is longitudinally centrally contained. Multiple glitters are fully adhered to the glue layer (2) to form a reflective layer (3). A transparent layer (4) with a smooth surface is fully coated on the reflective layer (3) and multiple patterns (5) are printed on the transparent layer (4) for providing a vivid appearance to a pencil.

The transparent layer (4) is formed of resin solution after being dried. The resin solution contains resin about 8˜15 percentage for providing a high transparency to the transparent layer.

Although the invention has been explained in relation to its preferred embodiment, it is to be understood that many other possible modifications and variations can be made without departing from the spirit and scope of the invention as hereinafter claimed.

1. A manufacturing method of a pencil surface comprising the following steps:
gluing: an outer periphery of a barrel of the pencil being allover glued for forming a glue layer;
forming a reflective layer: multiple glitters being fully adhered onto the outer periphery of the barrel to form a reflective layer;
forming a transparent layer: a transparent layer being formed on the reflective layer for providing a smooth surface to the pencil; and
patterning: the transparent layer being patterned for providing a vivid appearance of a pencil.

2. The manufacturing method as claimed in claim 1, wherein the barrel is fully dipped into transparent glue and the transparent layer is formed when the barrel is picked up from the transparent glue and the transparent glue is dried

3. The manufacturing method as claimed in claim 2, wherein the transparent glue is resin solution and contains resin about 8˜15 percentage.

4. A structure of a pencil surface comprising:
a glue layer adapted to be formed on an outer periphery of a barrel of the pencil in which a cartridge is longitudinally centrally contained;
multiple glitters being fully adhered to the glue layer to form a reflective layer;
a transparent layer with a smooth surface being fully coated on the reflective layer and multiple patterns being printed on the transparent layer for providing a vivid appearance to the pencil.

5. The structure of a pencil surface as claimed in claim 4, wherein the barrel is fully dipped into transparent glue and the transparent layer is formed when the barrel is picked up from the transparent glue and the transparent glue is dried

6. The manufacturing method as claimed in claim 5, wherein the transparent glue is resin solution and contains resin about 8˜15 percentage.
